(19) United States
(12) Patent Application Publication
(10) Pub. No.: US 2020/0149464 A1
(43) Pub. Date: May 14, 2020

(54) MULTI-COMPARTMENT COOLANT DE-AERATION RESERVOIR

(71) Applicant: Calsonic Kansei North America, Inc., Farmington Hills, MI (US)

(72) Inventors: BRYAN TRYTHALL, Carleton, MI (US); Dale S. Seyler, West Bloomfield, MI (US)

(21) Appl. No.: 16/186,005

(22) Filed: Nov. 9, 2018

(51) Int. Cl. F01P 11/02; B01D 19/00

(52) U.S. Cl. CPC F01P 11/028; F01P 11/0204; B01D 19/0073

(57) ABSTRACT

A coolant de-aeration reservoir for a vehicle includes a shell, a plurality of compartments defined in the shell, and an inlet and an outlet extending from each of the compartments. The plurality of compartments are fluidly connected to each other.

### BACKGROUND

The present application relates generally to the field of de-aeration reservoirs for coolant and more specifically to a single reservoir in a vehicle for providing coolant to multiple vehicle systems.

In a vehicle, coolant (e.g., water, oil, etc.) passes through various systems (e.g., HVAC, battery cooling, engine cooling, etc.). As the coolant flows through these systems, it passes through pumps, nozzles, radiators, and other components that affect the flow. Each of these components may cause cavitation in the fluid when the laminar flow of the fluid is disrupted at an edge or corner, generating turbulence, which in turn causes small air pockets to form in the coolant. Over time, the presence of the air pockets can damage the various components when the air pockets collapse, which may generate small shockwaves that are received by the corresponding device. Further, the presence of the air pockets within the coolant may disrupt the efficient transfer of heat to and from the coolant

Vehicles may de-aerate the coolant in the various systems by slowing down the flow in a reservoir, allowing it to rest so that the air may dissipate from the coolant. Generally, vehicles include separate de-aeration systems for each individual coolant cycle, further requiring separate reservoirs filled with coolant in the vehicle. These reservoirs take up valuable space in the vehicle and may be placed at different locations in the vehicle, making it more difficult to access all of the reservoirs to check and/or refill the coolant when servicing the vehicle.

It would be advantageous to provide a single de-aeration reservoir having multiple compartments that circulate coolant to various vehicle systems that require coolant and more particularly, to systems that utilize the same coolant. This and other advantages will be apparent to those reviewing the present application.

### SUMMARY

One embodiment relates to a coolant de-aeration reservoir for a vehicle, including a shell, a plurality of compartments defined in the shell, and an inlet and an outlet extending from each of the compartments. The plurality of compartments are fluidly connected to each other.

Another embodiment relates to a coolant de-aeration reservoir for a vehicle, including a shell having a lower end, a first wall extending upward from the lower end and a first compartment defined between the shell and the first wall, and a second wall extending upward from the lower end and a second compartment defined between the shell and the second wall. The reservoir further includes an upper surface extending between the first and second walls, and a recess extending into the upper surface. The recess fluidly connects the first and second compartments.

Another embodiment relates to a coolant de-aeration reservoir for a vehicle, including a shell having a lower end and an opposing upper end, at least one wall extending from the lower end of the shell to the upper end of the shell, and a plurality of compartments defined by the shell and the at least one wall. The reservoir further includes an inlet and an outlet extending from each of the compartments. The plurality of compartments are fluidly separated from each other in the shell.

### BRIEF DESCRIPTION OF THE DRAWINGS

FIG. 1 shows a perspective view of multi-compartment de-aeration reservoir according to an exemplary embodiment.

FIG. 2 shows the reservoir of FIG. 1 with the cover removed.

FIG. 3 is a bottom plan view of the isolated cover of FIG. 1.

FIG. 4 shows a perspective view of multi-compartment de-aeration reservoir according to another exemplary embodiment.

FIG. 5 shows the reservoir of FIG. 4 with the cover removed.

FIG. 6 is a top plan view of the reservoir as shown in FIG. 5.

FIG. 7 is a bottom plan view of the isolated cover of FIG. 4.

### DETAILED DESCRIPTION

Referring to the FIGURES generally, a de-aeration reservoir holds coolant for flowing through a vehicle system, such as an HVAC, battery cooling, or engine cooling system. Coolant is output from the reservoir to one or more vehicle systems, in which heat is transferred from the vehicle system to the coolant, such that the temperature in the coolant increases while the temperature in the vehicle system decreases. The coolant then passes through a radiator or other heat exchanger, which lowers the temperature of the coolant before the coolant is received back in the reservoir for de-aeration and recirculation in the corresponding coolant system.

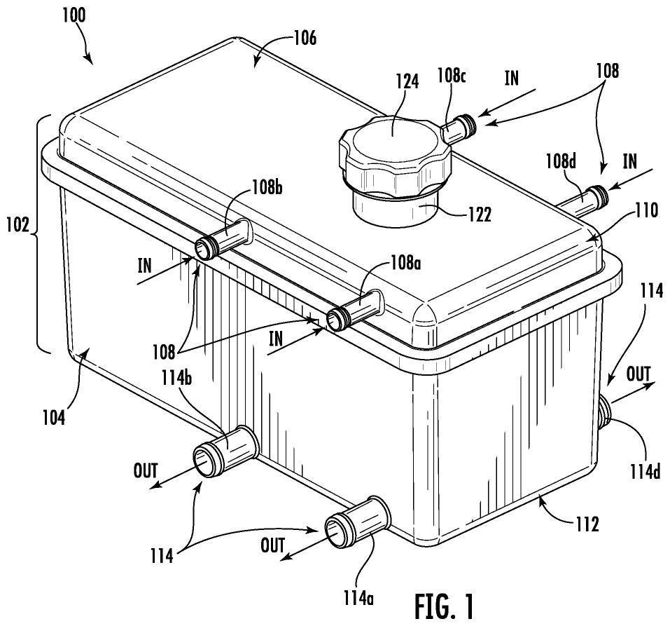

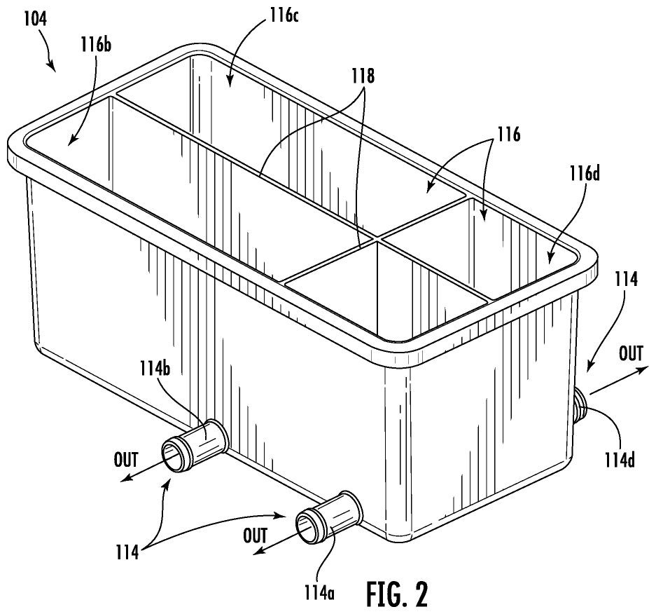

Referring now to FIG. 1, a de-aeration reservoir 100 (i.e., a reservoir) is shown according to an exemplary embodiment. The reservoir 100 includes a shell 102 (i.e., a shell assembly) configured to receive and de-aerate coolant in a vehicle. As shown in FIG. 2, the shell 102 may include a lower (i.e., first) body 104 and an opposing upper (i.e., second) body 106 disposed on the lower body 104. For example, the upper body 106 may be a lid, which sealingly engages the lower body 104, such that the shell 102 is sealed and configured to be pressurized to a pre-determined threshold pressure.

The reservoir 100 further includes a fill spout 122 (i.e., conduit), which is configured to receive coolant therethrough when the reservoir 100 is initially filled with coolant. Further, if the coolant level in the reservoir 100 falls below a threshold volume, additional coolant may be added to the reservoir 100 through the fill spout 122. As shown in FIG. 1, the fill spout 122 is disposed on and extends generally upward and away from an upper end 110 of the shell 102 (e.g., from the upper body 106). According to other exemplary embodiments, the fill spout 122 may be disposed on other portions of the shell 102 or may extend inward (i.e., internally) into the shell 102 instead of or in addition to extending outward (i.e., externally) from the shell 102. According to yet another exemplary embodiment, the reservoir 100 may include more than one fill spout 122 for providing the same or different types of coolant to various portions of the reservoir 100.

A cap 124 is disposed on and removably (e.g., threadably) coupled to the fill spout 122. The cap 124 sealingly engages the fill spout 122, such that an interior of the reservoir 100 is sealed from an external environment, allowing the reservoir 100 and corresponding coolant cycles to be pressurized. When the cap 124 is removed, a fill opening 126 (i.e., passage) as shown in FIG, 3, extends through the fill spout 122, to the interior of the reservoir 100, allowing a user to pass coolant through the fill spout 122 for filling the reservoir 100 without separating the upper body 106 from the lower body 104.

The reservoir 100 includes a plurality of inlets 108 (i.e., inlet connectors) configured to receive coolant in the reservoir 100 for de-aeration. Each inlet 108 may be disposed proximate the upper end 110 of the shell 102, such that when coolant is received in the reservoir 100, the coolant flows in a generally downward direction toward a lower end 112 of the shell 102. As shown in FIG. 1, the plurality of inlets 108 are formed as part of and extend from the upper body 106 of the shell 102, although according to other exemplary embodiments, one or more of the inlets 108 may extend from the lower body 104 (e.g., proximate the upper body 106) or other portion of the shell 102.

As shown in FIG. 1, the reservoir 100 includes four inlets 108. For example, the inlets 108 may include a first inlet 108a, a second inlet 108b, a third inlet 108c, and a fourth inlet 108d. Each inlet 108 corresponds to its own compartment in the reservoir 100. While FIG. 1 shows the reservoir 100 having four inlets 108, it should be understood that according to other exemplary embodiments, the reservoir 100 may include a greater or lesser number of inlets 108 corresponding with the number of compartments in the reservoir 100.

The reservoir 100 further includes a plurality of outlets 114 (i.e., outlet connectors) configured to output de-aerated coolant for reintroduction into various coolant system cycles. Each outlet 114 may be disposed proximate the lower end 112 of the shell 102, such that coolant in the reservoir 100 mixes and substantially all of the coolant is output from the outlets 114 at a consistent rate. As shown in FIG. 1, the plurality of outlets 114 are formed as part of and extend from the lower body 104 of the shell 102, although according to other exemplary embodiments, one or more of the outlets 114 may extend from the upper body 106 (e.g., proximate the lower body 104) or other portion of the shell 102.

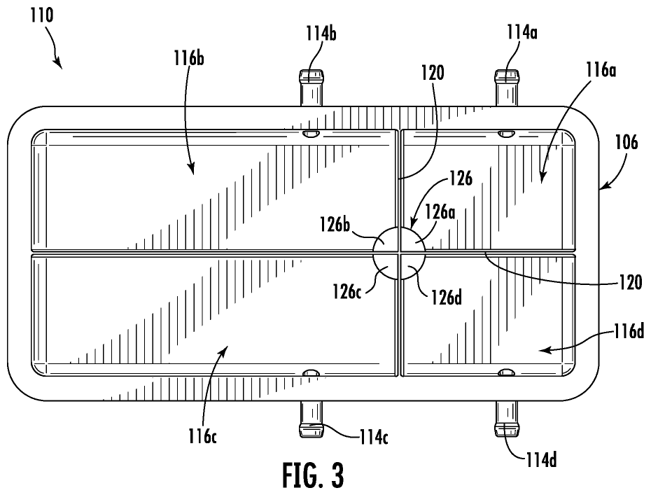

Referring to FIG. 2, the reservoir 100 includes a plurality of compartments 116 (i.e., chambers) defined therein. One or more lower walls 118 extend vertically upward from the lower end 112 of the shell 102 and the compartments 116 are defined by one or more of the lower walls 118 and/or the shell 102. The lower walls 118 may extend at least to an upper edge of the lower body 104. Referring to FIG. 3, a bottom plan view of the upper body 106 is shown according to an exemplary embodiment. The upper body 106 includes upper walls 120 extending downward from an upper end 110 toward the lower end 112 of the shell 102. The upper walls 120 are configured to be aligned with the lower walls 118, such that each of the compartments 116 extend fully between the lower end 112 and the upper end 110 of the shell 102 and are fluidly separated from each of the adjacent compartments 116. For example, the upper walls 120 may sealingly engage the lower walls 118 when the upper body 106 is installed on the lower body 104. According to another exemplary embodiment, the lower walls 118 may extend vertically upward above the upper edge of the lower body 104, such that the lower walls 118 directly engage the upper end 110 of the shell 102 (e.g., the upper body 106).

By fluidly separating each of the compartments 116, the reservoir 100 may contain different types of coolant in each of the compartments 116 without mixing the different coolants. For example, the single reservoir 100 may be used to supply coolant to vehicle systems that operate at different temperatures and therefore require different types of coolant. According to another exemplary embodiment, some or all of the compartments 116 may contain the same coolant. In this configuration, compartments 116 with the same coolant may still receive the coolant back from the various vehicle systems at different temperatures, although according to other exemplary embodiments, the vehicle systems may operate at substantially the same temperatures. Notably, in the event of a coolant leak, the separation of one coolant into a plurality of compartments 116 corresponding to different vehicle systems allows a user to identify which vehicle system has the coolant leak by identifying which compartment 116 is draining. In contrast, with a reservoir 100 with a single compartment connected to more than one vehicle system, a user would not be able to isolate a specific vehicle system for a leak just by monitoring the reservoir 100. It should be further understood that the reservoir 100 provides easy access for servicing coolant levels in each of the systems by placing all of the coolant in a single reservoir 100.

Referring again to FIG. 2, the reservoir 100 includes four compartments 116. For example, the compartments 116 may include a first compartment 116a, a second compartment 116b, a third compartment 116c, and a fourth compartment 116d. The first inlet 108a is fluidly connected to the first compartment 116a, the second inlet 108b is fluidly connected to the second compartment 116b, the third inlet 108c is fluidly connected to the third compartment 116c, and the fourth inlet 108d is fluidly connected to the fourth compartment 116d, such that coolant is received in each inlet 108 is provided downstream directly to the compartment 116 corresponding to the inlet 108. While FIG. 2 shows the reservoir 100 having four compartments 116, it should be understood that according to other exemplary embodiments, the reservoir 100 may include a greater or lesser number of compartments 116.

As shown in FIGS. 2 and 3, the reservoir 100 includes four outlets 114. For example, the outlets 114 may include a first outlet 114a, a second outlet 114b, a third outlet 114c (shown in FIG. 3), and a fourth outlet 114d. The first outlet 114a is fluidly connected to the first compartment 116a, the second outlet 114b is fluidly connected to the second compartment 116b, the third outlet 114c is fluidly connected to the third compartment 116c, and the fourth outlet 114d is fluidly connected to the fourth compartment 116d, such that coolant from each compartment 116 is output through its corresponding outlet 114. While FIG. 2 shows the reservoir 100 having four outlets 114, it should be understood that according to other exemplary embodiments, the reservoir 100 may include a greater or lesser number of outlets 114 corresponding to the number of compartments 116 in the reservoir 100.

Referring to FIG. 3, the fill opening 126 is shown according to an exemplary embodiment. The fill spout 122 and therefore the fill opening 126 may be upstream from and/or aligned with the various compartments 116, such that portions of the fill opening 126 are disposed directly above and aligned with each of the compartments 116. For example, the fill opening 126 includes a first portion 126a fluidly connected to the first compartment 116a, a second portion 126b fluidly connected to the second compartment 116b, a third portion 126c fluidly connected to the third compartment 126c, and a fourth portion 126d fluidly connected to the fourth compartment 116d. The upper walls 120 may extend upward into the fill opening 126, fluidly separating each of the portions 126a-126d, providing separate access to each of the compartments 116 at the fill spout 122. In this configuration, a user may selectively fill one or more of the compartments 116 with coolant while not filling the remaining compartments 116. In particular, if the reservoir 100 contains different types of coolant in different compartments 116, the separate portions of the fill opening 126 allows a user to fill a select compartment 116 with its required coolant without mixing the coolant into other compartments 116. While FIG, 3 shows the fill opening 126 having four separate portions 126a 126d, it should be understood that according to other exemplary embodiments, the fill opening 126 may include a greater or lesser number of separate portions corresponding to the number of compartments 116 in the reservoir 100.

Referring to FIGS. 2 and 3, the compartments 116 may have different volumes. Various vehicle systems may require different volumes of coolant flowing therethrough. For example, the volume of coolant may correlate directly with the amount of heat that must be transferred from a component in the system, such that an increase in coolant volume increases the amount of heat that may be transferred. According to another example, systems that are further away from the reservoir 100 or have more components may require additional coolant in order to fill the entire cycle with coolant. In order to address either of these or other situations, the compartments may have different sizes and volumes, such that the volume is greater for a system that requires additional coolant.

FIGS. 2 and 3 show the first compartment 116a and the fourth compartment 116d having the same volume as each other and the second compartment 116b and the third compartment 116c having the same volume as each other, which is also greater than the volume of the first and fourth compartments 116a, 116d. According to other exemplary embodiments, each of the compartments 116 may have the same or different volume as any other compartment 116. Regardless of the size of the compartments 116, each of the compartments 116 may intersect directly below the fill opening 126 to reliably provide coolant to each of the compartments 116, also allowing a user to easily provide fluid to just one compartment 116 at a time.

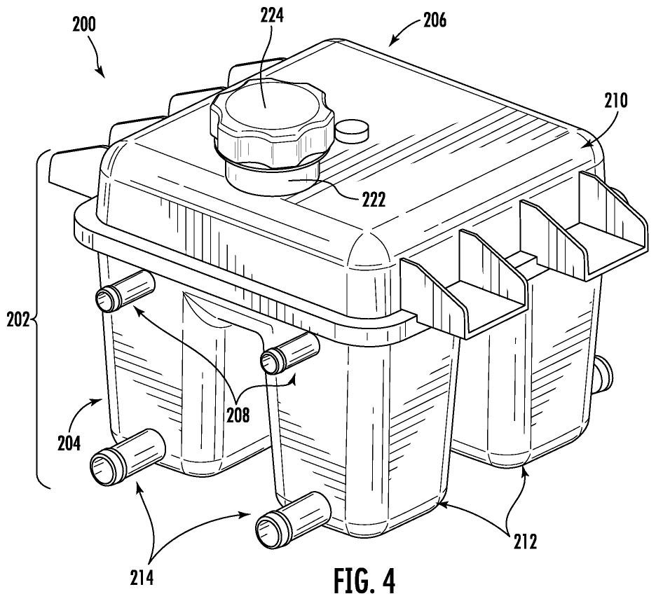

With reference to FIGS. 4-7, it should be understood that like elements having like reference numbers refer to the same element and have the same or similar features, except as described otherwise, as the reservoir 100 shown in FIGS. 1-3 and described above. Referring now to FIG, 4, a de-aeration reservoir 200 is shown according to another exemplary embodiment. The reservoir 200 includes a shell 202 configured to receive and de-aerate coolant in a vehicle. The shell 102 may include a lower (i.e., first) body 204 and an opposing upper (i.e., second) body 206 disposed on the lower body 204. For example, the upper body 206 may be a lid, which sealingly engages the lower body 204, such that the shell 202 is sealed and configured to be pressurized to a pre-determined threshold pressure.

The reservoir 200 further includes a fill spout 222, which is configured to receive coolant therethrough when the reservoir 200 is initially filled with coolant Further, if the coolant level in the reservoir 200 falls below a threshold volume, additional coolant may be inserted into the reservoir 200 through the fill spout 222. As shown in FIG. 4, the fill spout 222 is disposed on and extends generally upward and away from an upper end 210 of the shell 202 (e.g., from the upper body 206). According to other exemplary embodiments, the till spout 222 may be disposed on other portions of the shell 202 or may extend inward (i.e., internally) into the shell 202 instead of or in addition to extending outward (i.e., externally) from the shell 202. According to yet another exemplary embodiment, the reservoir 200 may include more than one fill spout 222 for providing the same or different types of coolant to various portions of the reservoir 200.

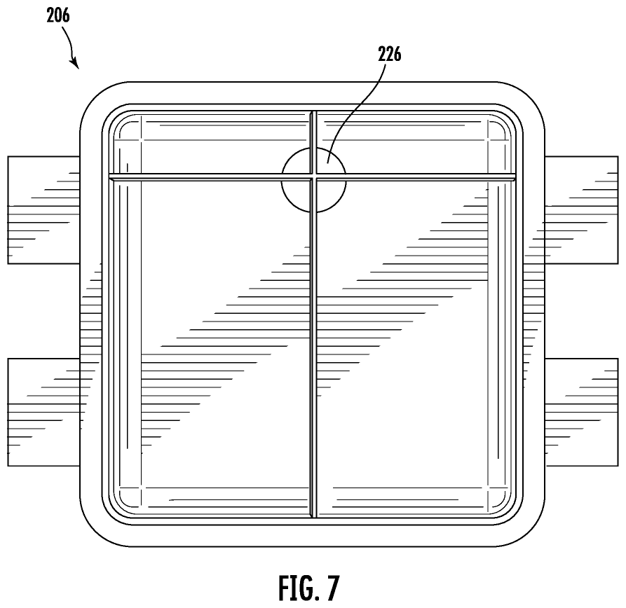

A cap 224 is disposed on and removably (e.g., threadably) coupled to the fill spout 222. The cap 224 sealingly engages the fill spout 222, such that an interior of the reservoir 200 is sealed from an external environment, allowing the reservoir 200 and corresponding coolant cycles to be pressurized. When the cap 224 is removed, a fill opening 226 (i.e., passage) as shown in FIG. 7, extends through the fill spout 222, to the interior of the reservoir 200, allowing a user to pass coolant through the fill spout 222 for filling the reservoir 200 without separating the upper body 206 from the lower body 204.

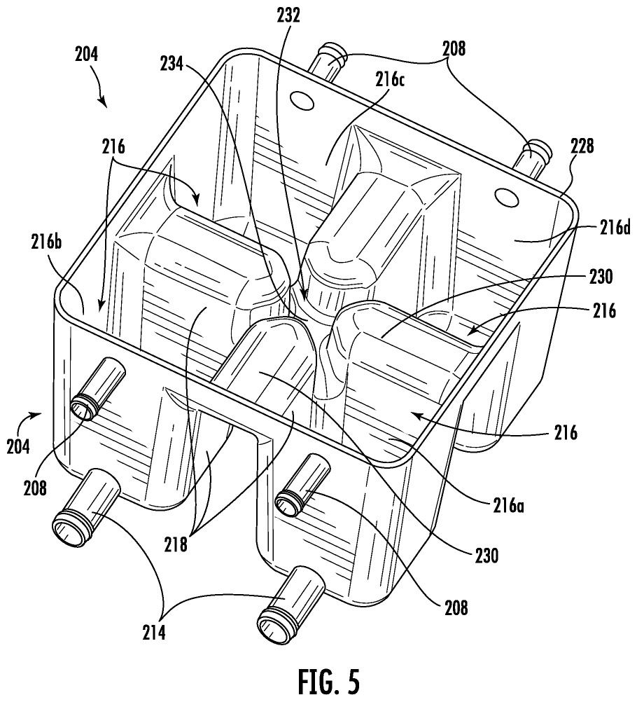

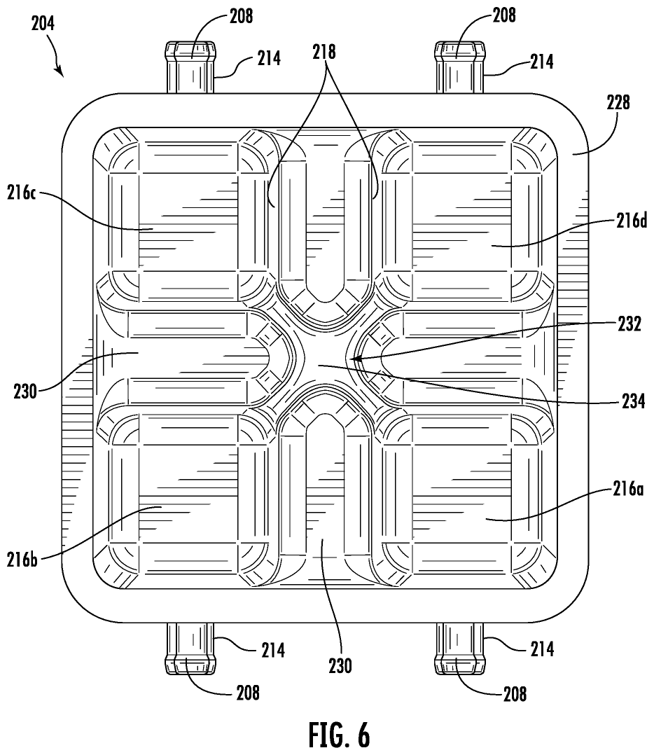

Referring now to FIGS. 5 and 6, the reservoir 200 includes a plurality of compartments 216 defined therein. One or more walls 218 extend vertically upward from the lower end 212 of the shell 202 and the compartments 216 are defined by one or more of the walls 218 and/or the shell 202. The lower body 204 includes an upper edge 228, which the upper body 206 engages when it is installed on the lower body 204. As shown in FIG. 5, an upper surface 230 extends laterally from and between each of the walls 218 (e.g., between first and second walls 218 corresponding to first and second compartments 216, respectively). The upper surface 230 is formed proximate but below (e.g., at a lower height than) the upper edge 228 of the lower body 204. According to other exemplary embodiments the upper surface 230 may be at a height above the upper edge 228 of the lower body 204 but spaced apart from (e.g., not engaging) the upper body 206 to ensure that coolant can pass over the walls 218 from one compartment 216 to another, such that the compartments 216 are fluidly connected over the walls 218. According to yet another exemplary embodiment, the upper surface 230 of the walls 218 may engage the upper body 206, but the compartments 216 may still be fluidly connected in other ways.

The walls 218 forming adjacent compartments 216 are spaced apart and connected by the upper surface 230 extending therebetween. In this configuration, the gap formed between the spaced apart walls 218 insulates the compartments 216 from passing heat therebetween and changing the temperature of coolant in one compartment 216 due to a different temperature of coolant in a different adjacent compartment 216. Specifically, different vehicle systems may require coolant to be supplied at different temperatures and it may therefore be advantageous to keep coolant in different compartments 216 at these different desired temperatures.

A recess 232 is formed in the walls 218 where each of the compartments 216 intersect and includes a recess surface 234 at a lower end of the recess 232. The recess 232 extends generally downward from the upper surface 230 of the walls 218, such that the recess surface 234 is disposed at a height (i.e., level) below the upper edge 228 of the lower body 204 and/or below the upper surface 230 of the walls 218. When coolant is filled in a compartment 216 to a level below the recess surface 234, it remains within the same compartment 216 or returns to the same compartment 216 after it has passed through a coolant cycle. If the coolant level rises above the recess surface 234, then excess coolant may be present in at least one of the compartments 216 relative to what is needed in the coolant cycle corresponding to (e.g., passing through) that compartment 216. The recess surface 234 fluidly connects each of the compartments 216, such that when coolant rises above the recess surface 234, it flows along the recess surface 234 and into one or more of the compartments 216 having a coolant level below the recess surface 234. In this configuration, the reservoir 200 internally distributes coolant between different compartments 216, which ensures that whether during the initial filling process, re-filling at a later date, or servicing the reservoir 200, coolant may be supplied directly to fewer than all of the compartments 216, while still distributing coolant to all of the compartments 216.

In the configuration shown in 5, the reservoir 200 may be used in a coolant system, which utilizes the same type of coolant for more than one coolant cycle. For example, a vehicle may use coolant to cool more than one battery module, each having its own coolant cycle. The modules may require the same type of coolant, allowing a user to fill all of the compartments 216 through the common fill spout 222, with coolant spilling over the recess 232 from one or more compartments 216 into the other compartments 216 until all of the compartments 216 are sufficiently full. This configuration may also simplify initial filling of the reservoir 200 because instead of measuring and inserting four specific volumes of coolant into separate reservoirs, a user only has to measure a single volume, which is then automatically internally distributed between each of the compartments 216.

As shown in FIGS. 5 and 6, the reservoir 200 includes four compartments 216, which are all fluidly connected by the recess 232. For example, the compartments 116 may include a first compartment 216a, a second compartment 216b, a third compartment 216c, and a fourth compartment 216d, with the recess 232 extending to each of the compartments 216. However, it should be understood that according to other exemplary embodiments, the reservoir 200 may include a greater or lesser number of compartments 216. According to yet another exemplary embodiment, the recess 232 may fluidly connect fewer than all of the compartments 216. For example, the walls 218 surrounding at least one of the compartments 216 (i.e., an isolated compartment) may extend all the way up to the upper body 206 and the recess 232 would not extend into the portion of the walls 218 surrounding that at least one compartment 216. In this configuration, the at least one of the compartments 216 may contain a different type coolant from the type of coolant being shared among each of the compartments 216 fluidly connected by the recess 232. As a result, the reservoir 200 may contain two or more types of coolant, while allowing coolant to flow between multiple fluidly connected compartments 216 for systems that all use the same coolant during operation.

The reservoir 200 includes a plurality of inlets 208 configured to receive coolant in the reservoir 200 for de-aeration. Each inlet 208 may be disposed proximate the upper end 210 of the shell 202, such that when coolant is received in the reservoir 200, the coolant flows in a generally downward direction toward a lower end 212 of the shell 102. As shown in FIG. 5, the plurality of inlets 208 are formed as part of and extend from the lower body 204 of the shell 202, proximate the upper edge 228. Each of the inlets 208 may be disposed at a height that is level with or below the upper surface 230 of the walls 218, which ensures that as coolant is output from the inlet 208 into the corresponding compartment 216, it generally does not inadvertently flow over the walls 218 into other compartments 216, maintaining substantially constant coolant levels in each of the compartments 216 during the vehicle's operation. According to other exemplary embodiments, one or more of the inlets 208 may extend from the lower body 204 at other locations.

Each of the inlets 208 may further be disposed at a height that is above the recess surface 234. In this configuration, if coolant completely fills a given compartment 216, the coolant passes through the recess 232 into another compartment 216 before it reaches the height of the inlet 208 corresponding to the overflowing compartment 216. This configuration allows the levels in the compartments 216 to self-regulate without causing a pressure buildup in any of the coolant cycles (e.g., due to coolant rising above the inlet 208, putting backpressure on the inlet 208).

As shown in FIGS. 5 and 6, the reservoir 200 includes four inlets 208. For example, each of the four compartments 216 may include an inlet 208 (e.g., one or more inlets) fluidly connected thereto. According to other exemplary embodiments, the reservoir 200 may include a greater or lesser number of inlets 208 corresponding to the number of compartments 216. According to yet another exemplary embodiment, because the compartments 216 are fluidly connected to each other, one or more of the compartments 216 may not have an inlet 208 disposed therein. For example, the reservoir 200 may include fewer inlets 208 than compartments 216, such that not all compartments have a corresponding inlet 208. According to another exemplary embodiment, the reservoir 200 may include the same number or more inlets 208 than compartments 216, in which case one or more of the compartments 216 include a plurality of corresponding inlets 208 while at least one of the compartments 216 does not include any inlets 208 disposed therein.

The reservoir 200 further includes a plurality of outlets 214 configured to output de-aerated coolant for reintroduction into various coolant system cycles. The plurality of outlets 214 are formed as part of and extend from the lower body 204 of the shell 202. Each outlet 214 may be disposed proximate the lower end 212 of the shell 202, such that coolant in the reservoir 200 mixes and substantially all of the coolant is output from the outlets 214 at a consistent rate. The reservoir 200 shown in FIGS. 5 and 6 includes four outlets 214 corresponding to the number of compartments 216 in the reservoir 200, such that each compartment 216 includes an outlet 214 disposed therein. However, it should be understood that according to other exemplary embodiments, the reservoir 200 may include a greater or lesser number of outlets 214 corresponding to a greater or lesser number of compartments 216 formed in the reservoir 200. According to another exemplary embodiment, one or more of the compartments 216 may include a plurality of outlets disposed therein.

Referring to FIG. 7, the fill opening 226 is shown according to an exemplary embodiment. The fill spout 222 and therefore the fill opening 226 may be aligned with two or more compartments 216, such that portions of the fill opening 226 are disposed directly above and aligned with the two or more compartments 216 or directly above the wall 218 disposed between the two or more compartments 216. For example, as shown in FIG. 7, the fill opening 226 is off-center from the upper body 206. In this configuration, the fill opening 226 is disposed directly above two compartments 216 (i.e., upstream compartments) and/or the upper surface 230 of the walls 218 extending between the two adjacent compartments 216. The remaining compartments 216 (i.e., downstream compartments) are positioned downstream from the upstream compartments 216 directly below the fill opening 226 and the downstream compartments 216 are filled when the coolant level in the compartments 216 directly below the fill opening 226 reaches the height of the recess surface 234. According to yet another exemplary embodiment, the fill opening 226 may be disposed directly above just one of the compartments 216, such that all the remaining compartments 216 are downstream from the one upstream compartment 216 directly below the fill opening 226.

According to another exemplary embodiment, the fill opening 226 may be disposed directly above the recess 232, such that when coolant is supplied to the reservoir 200, it falls downward through the fill opening 226 and first contacts the recess surface 234 in the reservoir, before being divided substantially evenly in the recess 232 and into each of the compartments 216. In this configuration, each of the compartments 216 may be filled with substantially the same volume of coolant by supplying a single measured volume of coolant at a common fill opening 226.

Referring to FIGS. 5 and 6, the compartments 216 may have substantially the same volumes and may be configured to hold the same volume of coolant as the other compartments 216. However, according to other exemplary embodiments, two or more of the compartments 216 may have different volumes. In this configuration, various vehicle systems may require different volumes of coolant flowing therethrough and may be provided with different volumes of coolant depending on which compartment 216 the system is coupled to. According to yet another exemplary embodiment, in the configuration with the fill opening 226 in the off-center location shown in FIG. 7, the upstream compartments 216 are filled before the downstream compartments 216. As a result, the upstream compartments 216 reach the level of the recess surface 234. The filling process may be stopped before the level of coolant in the downstream compartments 216 reaches the recess surface 234, such that the downstream compartments 216 have a smaller volume of coolant therein than the upstream compartments 216. The downstream compartments 216 may then be coupled to vehicle systems that require less coolant and the upstream compartments 216 may be coupled to vehicle systems that require more coolant.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof; various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, mounting arrangements, use of orientations, manufacturing processes, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A coolant de-aeration reservoir for a vehicle comprising:
a shell;
a plurality of compartments defined in the shell; and
an inlet and an outlet extending from each of the compartments;
wherein the plurality of compartments are fluidly connected to each other.

2. The reservoir of claim 1, wherein the plurality of compartments are fluidly connected at an upper end thereof.

3. The reservoir of claim 2, further comprising a recess formed proximate the upper end of the compartments and fluidly connecting each of the compartments.

4. The reservoir of claim 3, wherein each inlet is disposed below the upper end of the compartment and above a lower end of the recess.

5. The reservoir of claim 3, further comprising a fill opening disposed directly above the recess.

6. The reservoir of claim 1, further comprising a fill opening disposed directly above two or more compartments.

7. The reservoir of claim 1, further comprising a fill opening disposed directly above only one compartment.

8. The reservoir of claim 1, wherein each of the compartments 1s spaced apart from the other compartments.

9. A coolant de-aeration reservoir for a vehicle comprising:
a shell having a lower end;
a first wall extending upward from the lower end and a first compartment defined between the shell and the first wall;
a second wall extending upward from the lower end and a second compartment defined between the shell and the second wall;
an upper surface extending between the first and second walls; and
a recess extending into the upper surface, the recess fluidly connecting the first and second compartments,

10. The reservoir of claim 9, wherein:
the shell comprises a lower body and an opposing upper body disposed on the lower body;
the first and second walls extend upward from the lower body toward the upper body; and
the upper surface is spaced apart from the upper body.

11. The reservoir of claim 9, wherein the recess comprises a recess surface extending between the first and second compartments at a height below the upper surface.

12. The reservoir of claim 11, wherein each compartment comprises an inlet extending therefrom at a height above the recess surface.

13. The reservoir of claim 12, wherein the inlet is disposed at a height below the upper surface.

14. The reservoir of claim 12, wherein:
the shell comprises an upper end; and
the upper surface is disposed at a height below the upper end of the shell.

15. The reservoir of claim 14, wherein the inlet is disposed at a height below the upper end of the shell.

16. A coolant de-aeration reservoir for a vehicle comprising:
a shell having a lower end and an opposing upper end;
at least one wall extending from the lower end of the shell to the upper end of the shell;
a plurality of compartments defined by the shell and the at least one wall; and
an inlet and an outlet extending from each of the compartments;
wherein the plurality of compartments are fluidly separated from each other in the shell.

17. The reservoir of claim 0, wherein:
the shell comprises a lower shell and an upper shell disposed on the lower shell;
the at least one wall comprises a lower wall formed in the lower shell and an upper wall formed in the upper shell; and
the upper wall is aligned with and sealingly engages the lower wall.

18. The reservoir of claim 17, further comprising a fill opening fluidly coupled to each of the compartments and configured to receive coolant therethrough.

19. The reservoir of claim 18, wherein the upper wall extends into the fill opening and divides the opening into a plurality of fluidly separate portions corresponding to each of the compartments.

20. The reservoir of claim 18, wherein the fill opening is disposed directly above each of the compartments.
